(19) United States
(12) Patent Application Publication
(10) Pub. No.: US 2026/0106237 A1
(43) Pub. Date: Apr. 16, 2026

(54) PIEZO-RESISTIVE PRESSURE SENSOR AND METHOD FOR MANUFACTURING THE SAME

(71) Applicants: HYUNDAI MOTOR COMPANY, SEOUL (KR); KIA CORPORATION, SEOUL (KR); CHUNG ANG UNIVERSITY INDUSTRY ACADEMIC COOPERATION FOUNDATION, Seoul (KR)

(72) Inventors: Jang Hyeon Lee, Hwaseong-si (KR); Dong Gu Kim, Hwaseong-si (KR); Deok Woo Yun, Hwaseong-si (KR); Gwan Sik Kim, Hwaseong-si (KR); Kyong Hwa Song, Hwaseong-si (KR); Seok Min Lee, Hwaseong-si (KR); Dong Hyun Lee, Seoul (KR); Seong Beom Heo, Seoul (KR); Gyeong Wan Lee, Seoul (KR); Jung Wook Choi, Seoul (KR)

(73) Assignees: HYUNDAI MOTOR COMPANY, SEOUL (KR); KIA CORPORATION, SEOUL (KR); CHUNG ANG UNIVERSITY INDUSTRY ACADEMIC COOPERATION FOUNDATION, Seoul (KR)

(21) Appl. No.: 19/249,675

(22) Filed: Jun. 25, 2025

(30) Foreign Application Priority Data
Oct. 11, 2024 (KR) 10-2024-0138951

(51) Int. Cl. H01M 10/42; H01M 10/44

(52) U.S. Cl. CPC H01M 10/4257; H01M 10/445; H01M 2200/105; H01M 2200/106; H01M 2200/20; H01M 2220/20

(57) ABSTRACT

A piezo-resistive pressure sensor includes: a first electrode layer including an electrode material having a positive temperature coefficient of resistance (PTC); a first sensing layer laminated on the first electrode layer, and including a conductive material having a negative temperature of coefficient of resistance (NTC); a second sensing layer laminated to contact or be spaced apart from the first sensing layer, and including a conductive material having a negative temperature coefficient of resistance (NTC); and a second electrode layer laminated on the second sensing layer, and including an electrode material having a positive temperature coefficient of resistance (PTC).

### CROSS-REFERENCE TO RELATED APPLICATION

This application claims the benefit of and priority to Korean Patent Application No. 10-2024-0138951, filed in the Korean Intellectual Property Office on Oct. 11, 2024, the entire contents of which are incorporated herein by reference.

### TECHNICAL FIELD

The present disclosure relates to a piezo-resistive pressure sensor with enhanced pressure sensing capability for environments with fluctuating temperatures, such as a vehicle, and a method for manufacturing the same.

### BACKGROUND

Batteries are widely used in various fields, such as portable devices, electric vehicles, and energy storage devices in that they have high energy density and long-term use. However, abnormal operation of these batteries may occur under certain environmental conditions, such as mechanical abnormal conditions, electrical abnormal conditions, thermal abnormal conditions, internal short circuits, and the like. In various examples, the vehicle battery may have a thermal runaway phenomenon, in which an electro-chemical heating reaction inside the battery is promoted to a dangerous level due to repeated overcharging and discharging, long-term use, physical damage, and the like. Monitoring abnormalities in the battery in real time is necessary to prevent such a thermal runaway phenomenon, thus, monitoring methods using various sensors, such as temperature sensors, gas sensors, and pressure sensors, have been proposed.

For example, temperature-based methods detect thermal runaway by measuring the temperature inside the battery. However, these methods can suffer from reduced reliability due to heat loss caused by gas emissions resulting from electrochemical reactions within the battery. Furthermore, gas sensor-based methods have limitations in that gas may be sensed after serious damage to the inside of the battery has occurred, making initial diagnosis of thermal runaway difficult.

A method using a pressure sensor may initially sense an abnormal condition of a battery by monitoring a change in pressure generated by swelling of a battery cell in real time. However, conventional pressure sensors are difficult to apply in conditions when a high reliability, e.g., as in a vehicle battery is required, because the battery resistance value is changed due to changes in ambient temperature.

Capacitive pressure sensors and piezo-resistive pressure sensors are typical pressure sensors that are applied to conventional vehicles. The capacitive pressure sensor uses a capacitance that is changed as a diaphragm is deformed by an external pressure and a distance between an electrode on the diaphragm and an electrode on a lower substrate is changed. Such a capacitive pressure sensor has a low temperature coefficient of resistance, a low power loss, and a stable signal response, but it needs a large element area and uses a capacitance as an output signal, so that it needs a complex signal processor and has a low hysteresis performance. The piezo-resistive pressure sensor uses a resistor that is located on a diaphragm, of which a resistance value is changed by an external pressure. The piezo-resistive pressure sensor has enhanced linearity and easy signal processing, but has a low sensitivity and a higher temperature dependence than those of the capacitive type.

Accordingly, it is desired to research and develop pressure sensors with enhanced pressure sensing capabilities that maintain high accuracy even in environments with fluctuating temperatures, such as those found in vehicles, due to low temperature dependence.

### SUMMARY

The present disclosure has been made to solve the above-mentioned problems occurring in the prior art while advantages achieved by the prior art are maintained intact.

An aspect of the present disclosure provides a piezo-resistive pressure sensor that has enhanced pressure sensing capability even in an environment with fluctuating temperature, such as a vehicle, due to a low temperature dependence compared to a conventional piezo-resistive pressure sensor.

The technical problems to be solved by the present disclosure are not limited to the aforementioned problems, and any other technical problems not mentioned herein should be clearly understood from the following description by those having ordinary skill in the art to which the present disclosure pertains.

According to an embodiment of the present disclosure, a piezo-resistive pressure sensor may include: a first electrode layer having an electrode material with a positive temperature coefficient of resistance (PTC); a first sensing layer laminated on the first electrode layer, and including a conductive material having a negative temperature of coefficient of resistance (NTC); and a second sensing layer laminated to contact or be spaced apart from the first sensing layer, and including a conductive material having a negative temperature coefficient of resistance (NTC). Additionally, the piezo-resistive pressure sensor may include a second electrode layer laminated on the second sensing layer, and including an electrode material having a positive temperature coefficient of resistance (PTC).

According to an embodiment of the present disclosure, a method for manufacturing a piezo-resistive pressure sensor may include an electrode layer forming process of forming a first electrode layer and a second electrode layer. The method may also include a sensing layer forming process of forming a first sensing layer and a second sensing layer, by applying a composition for the first sensing layer onto the first electrode layer, applying a composition for the second sensing layer onto the second electrode layer, and heating the compositions. The method may also include an assembly process of laminating the first sensing layer and the second sensing layer such that the first sensing layer and the second sensing layer contact or are spaced apart from each other. The first electrode layer and the second electrode layer may include an electrode material having a positive temperature coefficient of resistance (PTC) respectively, and the composition for the first sensing layer and the composition for the second sensing layer may include a conductive material having a negative temperature coefficient of resistance (NTC) respectively.

According to an embodiment, a battery including the piezo-resistive pressure sensor may be provided.

### BRIEF DESCRIPTION OF THE DRAWINGS

The above and other objects, features, and advantages of the present disclosure should be more apparent from the following detailed description taken in conjunction with the accompanying drawings:

FIG. 1 is a cross-sectional schematic diagram of a piezo-resistive pressure sensor according to an embodiment of the present disclosure;

FIG. 2 schematically illustrates a method for measuring a pressure of a piezo-resistive pressure sensor according to an embodiment of the present disclosure;

FIG. 3 schematically illustrates a state, in which an electrode layer and a sensing layer are stacked in a piezo-resistive pressure sensor according to an embodiment of the present disclosure;

FIG. 4 is a cross-sectional schematic diagram of a piezo-resistive pressure sensor according to an embodiment of the present disclosure;

FIG. 5 is a cross-sectional schematic diagram of a battery according to an embodiment of the present disclosure;

FIG. 6 illustrates a dimension of a piezo-resistive pressure sensor manufactured in an embodiment of the present disclosure;

FIG. 7 is a surface Scanning Electron Microscope (SEM) photograph of a first electrode layer according to an embodiment of the present disclosure, measured in a first test example;

FIG. 8 is a surface Scanning Electron Microscope (SEM) photograph of a first sensing layer manufactured in a first embodiment;

FIG. 9 is a photograph obtained by observing a surface of a first sensing layer manufactured in a first embodiment with a confocal microscope;

FIG. 10 is a photograph obtained by observing a surface of a first sensing layer manufactured in a first embodiment with an atomic microscope;

FIG. 11 illustrates a result of measuring a current while applying a pressure to a pressure sensor of a first embodiment and a surface untreated pressure sensor;

FIG. 12 illustrates a current-voltage curve result measured for a pressure sensor of a fourth embodiment and a pressure sensor of a fifth embodiment;

FIG. 13 illustrates a temperature coefficient of resistance (TCR) measurement result of a pressure sensor of a fourth embodiment;

FIG. 14 illustrates a measurement result of a change in a resistance of a pressure sensor based on a temperature thereof according to an embodiment of the present disclosure;

FIG. 15 illustrates a measurement result of a change in a voltage of a pressure sensor based on an applied pressure thereof according to an embodiment of the present disclosure; and

FIGS. 16A and 16B are graphs depicting a change in voltage based on charging and discharging of a battery and a change in voltage sensed by a pressure sensor.

### DETAILED DESCRIPTION

Hereinafter, the present disclosure is described in detail.

In the specification, when a portion “include” and “comprises” a component, it means that it can further include other component, without excluding other components unless specifically stated otherwise.

Furthermore, in the specification, when it is supposed that a member is located on “a surface”, “an opposite surface”, or “opposite surfaces” of another member, this includes not only the case, in which one member contacts another member but also the case, in which another member is present between two other members.

### Piezo-Resistive Pressure Sensor

A piezo-resistive pressure sensor according to the present disclosure includes: a first electrode layer including an electrode material having a positive temperature coefficient of resistance (PTC); and a first sensing layer that is stacked on the first electrode layer, and includes a conductive material having a negative temperature of coefficient of resistance (NTC). The piezo-resistive pressure sensor also includes: a second sensing layer that is stacked to contact or be spaced apart from the first sensing layer, and includes a conductive material having a negative temperature coefficient of resistance (NTC); and a second electrode layer stacked on the second sensing layer, and includes an electrode material having a positive temperature coefficient of resistance (PTC).

As described above, the pressure sensor according to the present disclosure has an electrode material in an electrode layer and a conductive material in a sensing layer having opposite temperature resistance coefficients. As a result, a temperature sensitivity may be lowered to allow stable and reliable detection of change of a pressure that is a sensing target in an environment with fluctuating temperatures, such as a vehicle, by controlling a temperature coefficient of resistance of the entire pressure sensor.

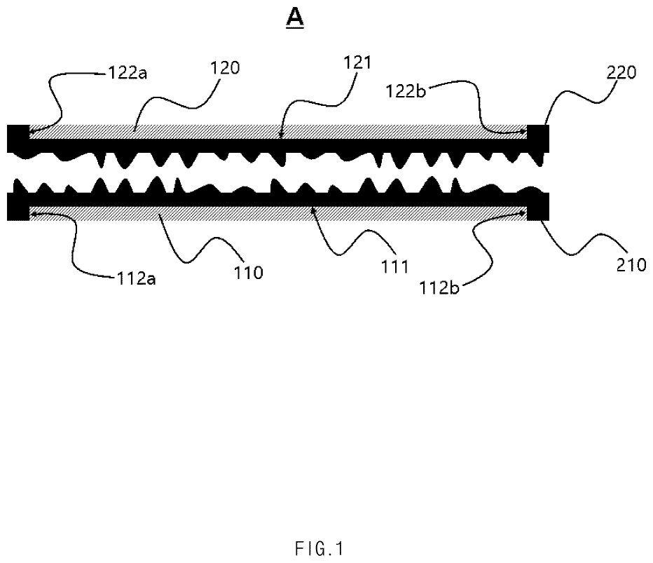

Referring to FIG. 1, the piezo-resistive pressure sensor A may include a form, in which a first electrode layer 110, a first sensing layer 210, a second sensing layer 220, and a second electrode layer 120 are sequentially laminated. For example, the first sensing layer 210 and the second sensing layer 220 may contact or be spaced apart from each other.

### First Electrode Layer and Second Electrode Layer

Each of the first electrode layer 110 and the second electrode layer 120 include an electrode material having a positive temperature coefficient of resistance (PTC).

The electrode material may include one or more selected from the group consisting of silver (Ag), gold, copper, platinum, palladium, nickel, aluminum, cobalt, molybdenum, tungsten, titanium, and chromium. In various examples, the electrode material may include silver (Ag).

Furthermore, the electrode material is not particularly limited as long as it may control resistance, and, for example, may have a form, such as nanowires, nanoparticles, and thin films. In various examples, the electrode material may be in the form of a nanowire.

### First Sensing Layer and Second Sensing Layer

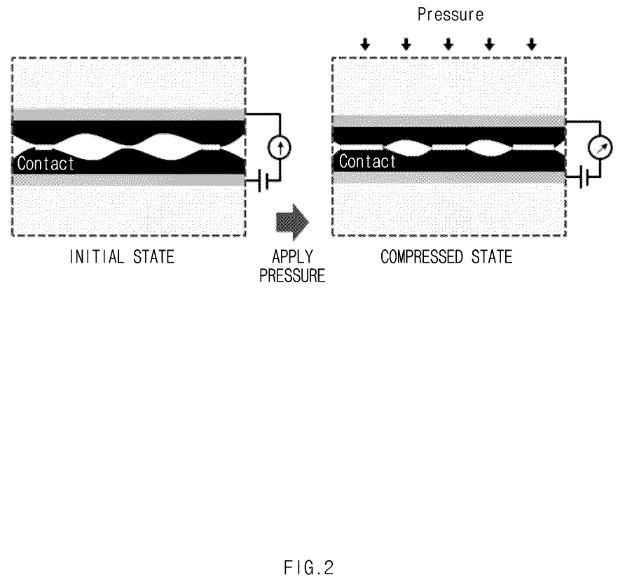

The first sensing layer 210 and the second sensing layer 220 are stacked to contact or be spaced apart from each other, and a contact area therebetween is changed due to a change in the applied pressure. As a result, the first sensing layer 210 an the second sensing layer 220 serve to sense a change in the pressure as an electrical response is changed. For example, referring to FIG. 2, when a pressure is applied to the pressure sensor A, the contact area between the first sensing layer 210 and the second sensing layer 220 increases, and the electrical response changes so that a change in the pressure may be sensed.

In various examples, the first sensing layer 210 and the second sensing layer 220 may partially contact each other (see FIG. 1).

Furthermore, each of the first sensing layer 210 and the second sensing layer 220 may have a surface roughness (Ra) of 0.001 μm or more and 1000 μm or less respectively. For example, a surface roughness (Ra) of each of facing surfaces of the first sensing layer 210 and the second sensing layer 220 may be 0.001 μm or more, 0.01 μm or more, 0.02 μm or more, 0.1 μm or more, 1000 μm or less, 500 μm or less, 100 μm or less, 20 μm or less, or 10 μm or less. In other words, the facing surfaces of the first sensing layer 210 and the second sensing layer 220 may not be flat, and, e.g., may include shapes, such as a convexo-concave shape, a convex shape, and a concave shape (see FIG. 1).

Because the facing surfaces of the first sensing layer 210 and the second sensing layer 220 are not flat, a contact area, in which they contact each other, is changed by a pressure applied to the pressure sensor A, and an electrical response is changed so that the pressure may be effectively sensed based on this change in the electrical response. For example, because the piezo-resistive pressure sensor A of the present disclosure may control the sensitivity and the pressure sensing range by controlling the roughness of the facing surface of the first sensing layer 210 and the second sensing layer 220, the surface roughness of each of the first sensing layer 210 and the second sensing layer 220 may be adjusted based on the desired sensitivity and pressure sensing range. Furthermore, the sensitivity and pressure sensing range are typically inversely proportional to each other in the piezo-resistive pressure sensor A.

The first sensing layer 210 and the second sensing layer 220 may include a polymer respectively. The polymer serves to maintain the shape of the sensing layer and maintain a conductive path between the conductive materials.

The polymer may include a fluorine-based polymer. For example, the fluorine-based polymer may be a polymer of one or more monomer selected from the group consisting of vinylidene fluoride (VDF), hexafluoropropylene (HFP), and tetrafluoroethylene (TFE). In detail, the fluorine-based polymer may include polyvinylidene fluoride (PVDF).

Additionally, the polymer may have a weight average molecular weight (Mw) of 100,000 g/mol or more, 150,000 g/mol or more, 200,000 g/mol or more, 300,000 g/mol or more, 350,000 g/mol or more, 400,000 g/mol or more, 450,000 g/mol or more, 500,000 g/mol or more, 700,000 g/mol or less, 650,000 g/mol or less, 600,000 g/mol or less, 580,000 g/mol or less, or 550,000 g/mol or less. When the average molecular weight of the polymer is within the range, mechanical properties of the sensing layer and dispersibility of the conductive material may be improved. In various examples, when the average molecular weight of the polymer is equal to or greater than a lower limit, the problem of an insufficient durability due to the low mechanical properties of the sensing layer may be prevented. Additionally, when the average molecular weight is equal to or less than an upper limit, the problem of the decreased dispersibility of the conductive material due to a high viscosity of the sensing layer composition may be prevented.

The conductive material has a negative temperature coefficient of resistance (NTC). For example, the conductive material may include one or more selected from the group consisting of a carbon nano material and a semiconductor. In various examples, the conductive material may include a carbon nano material.

The carbon nano material may include one or more selected from the group consisting of a carbon nanotube (CNT), graphene, carbon black, and graphite. In various examples, the carbon nano material may include carbon nanotubes.

The semiconductor may include one or more selected from the group consisting of zinc oxide (ZnO), titanium dioxide (TiO₂), tungsten trioxide (WO₃), tin (IV) oxide (SnO₂), nickel (II) oxide (NiO), copper (II) oxide (CuO), chromium (III) oxide (Cr₂O₃), chromium (VI) oxide (CrO₃), chromium (II) oxide (CrO), cobalt (II) oxide (CoO), cobalt (III) oxide (Co₂O₃), and cobalt (II,III) oxide (Co₃O₄).

In the pressure sensor A, the electrode material, the conductive material, and the polymer may be included in a weight ratio of 1:0.90 or more and 3.5 or less: 25 or more and 90 or less. For example, the weight of each of the electrode material, the conductive material, and the polymer means a total amount of the electrode material in the pressure sensor, a total amount of the conductive material in the pressure sensor, and a total amount of the polymer in the pressure sensor. For example, a weight ratio of the electrode material, the conductive material, and the polymer may be appropriately adjusted based on the targeted sensitivity of the pressure sensor A based on each of the materials.

In various examples, the pressure sensor A may include the electrode material and the conductive material at a ratio of 1:0.95 or more and 3.5 or less, 1:0.98 or more and 2.9 or less, 1:1.0 or more and 2.6 or less, or 1:1.20 or more and 2.0 or less.

In various examples, the pressure sensor A may include the electrode material and the polymer at a weight ratio of 1:25 or more and 90 or less, a weight ratio of 1:27 or more and 70 or less, a weight ratio of 1:28 or more and 55 or less, or a weight ratio of 1:29 or more and 32 or less.

When the weight ratio of the electrode material, the conductive material, and the polymer is within the range, it is possible to achieve a low temperature sensitivity of the pressure sensor A and measure a change in the pressure in a fluctuation temperature environment, such as a vehicle as a change by the pressure is appropriate.

Referring to FIG. 1, in the pressure sensor A, with respect to a cross section of the pressure sensor A, the first sensing layer 210 may cover one surface and one or more side surface of the first electrode layer 110, and the second sensing layer 220 may cover one surface and one or more side surface of the second electrode layer 120.

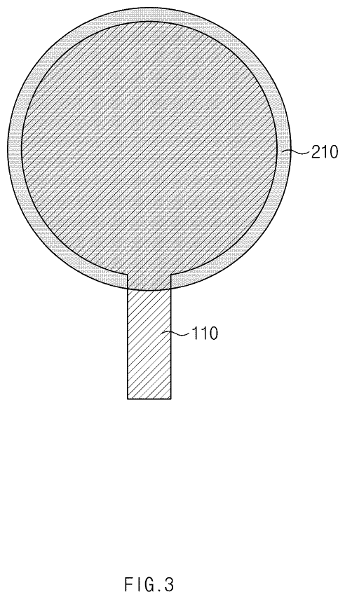

Referring to FIGS. 1 and 3, the first sensing layer 210 may cover one surface and side surfaces of the first electrode layer 110. Furthermore, the second sensing layer 220 may cover one surface and side surfaces of the second electrode layer 120.

The pressure sensor A may further include a first base layer on the first electrode layer 110 on an opposite surface to the surface, on which the first electrode layer and the first sensing layer contact each other. Furthermore, the pressure sensor A may further include a second base layer on the second electrode layer 120 on an opposite surface to the surface, on which the second electrode layer and the second sensing layer contact each other.

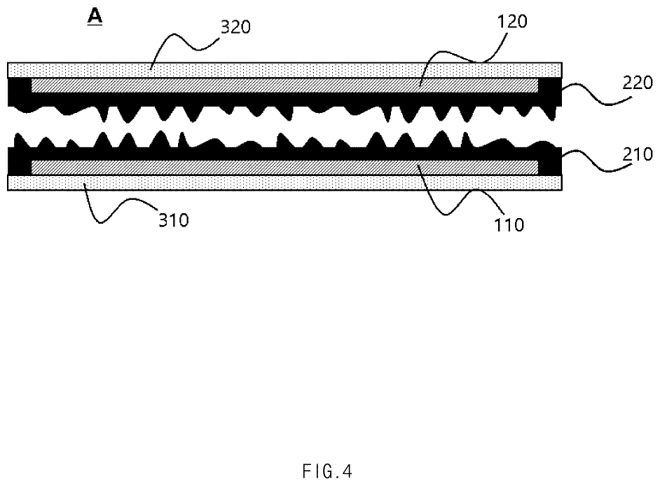

Referring to FIG. 4, the pressure sensor A may include a form, in which a first base layer 310, a first electrode layer 110, a first sensing layer 210, a second sensing layer 220, a second electrode layer 120, and a second base layer 320 are sequentially laminated.

### First Base Layer and Second Base Layer

For example, the first base layer 310 and the second base layer 320 may be typically used without particular limitation as long as they are generally usable as a base layer of the pressure sensor A. Furthermore, for example, the first base layer 310 and the second base layer 320 may include polyethylene terephthalate (PET), polyethylene (PE), polypropylene (PP), polybutylene terephthalate (PBT), polytrimethylene terephthalate (PTT), polyimide (PI), polyamide (PA), polyurethane (PU), polyvinylidene fluoride (PVDF), polydimethylsiloxane (PDMS), polybutadiene (PB), polyurethane acrylate (PUA), and styrene butadiene copolymer (SBR).

Furthermore, the first base layer 310 and the second base layer 320 may be typically used without particular limitation as long as they may be used as base layers of the pressure sensor A. For example, each of the first base layer 310 and the second base layer 320 may have an average thickness of 50 μm or more, 80 μm or more, 100 μm or more, 150 μm or more, 500 μm or less, 300 μm or less, 250 μm or less, or 200 μm or less respectively.

Because the piezo-resistive pressure sensor A according to the present disclosure as described above has a lower temperature dependence compared to the conventional piezo-resistive pressure sensor, it has an enhanced pressure sensing capability even in a temperature-changing environment, such as a vehicle. Therefore, the piezo-resistive pressure sensor A is very suitable for monitoring an abnormality of the battery in real time. Furthermore, the remaining capacity and state of health of the battery may be calculated from the results measured by the pressure sensor A, and thus, it is very suitable for monitoring the current state of the battery.

### Method for Manufacturing Piezo-Resistive Pressure Sensor

A method for manufacturing a piezo-resistive pressure sensor according to the present disclosure includes an electrode layer forming process of forming a first electrode layer and a second electrode layer. The method also includes a sensing layer forming process of forming a first sensing layer and a second sensing layer, by applying a composition for the first sensing layer onto the first electrode layer, applying a composition for the second sensing layer onto the second electrode layer, and heating the compositions. The method also includes an assembly process of stacking the first sensing layer and the second sensing layer such that the first sensing layer and the second sensing layer contact or are spaced apart from each other.

### Electrode Layer Forming Process

In this process, the first electrode layer and the second electrode layer are formed, respectively.

Each of the first electrode layer and the second electrode layer include an electrode material having a positive temperature coefficient of resistance (PTC) respectively. The electrode material having the positive temperature coefficient of resistance is as described in the piezo-resistive pressure sensor.

The electrode layer forming process may be applied without particular limitation as long as it is a method that is typically used to form an electrode layer by using a metal or the like, and for example, screen printing, spin coating, spray coating, and the like may be used. In various examples, the electrode layer may be formed by using screen printing.

For example, the first electrode layer may be formed by using the first electrode layer composition including an electrode material having a positive temperature coefficient of resistance on the first base layer, and the second electrode layer may be formed by using the second electrode layer composition including an electrode material having a positive temperature coefficient of resistance on the second base layer. For example, each of the first base layer and the second base layer is as described in the piezo-resistive pressure sensor.

Each of the first electrode layer composition and the second electrode layer composition may include an electrode material having a positive temperature coefficient of resistance and a solvent. The solvent may be used without particular limitation as long as the electrode material may be dispersed, and, for example, may include water, ethanol, methanol, isopropyl alcohol, ethylene glycol, and the like.

In addition, each of the first electrode layer composition and the second electrode layer composition may include the electrode material in a content of 0.05 wt % or more, 0.08 wt % or more, 0.10 wt % or more, 0.15 wt % or more, 0.20 wt % or more, 0.25 wt % or more, 0.50 wt % or less, 0.45 wt % or less, 0.40 wt % or less, or 0.35 wt % or less based on a total weight of the composition. When the content of the electrode material in the electrode layer composition is within the range, the content of the electrode material in the composition is appropriate so that the electrical response of the manufactured pressure sensor may be effectively measured.

### Process of Forming Sensing Layer

In this process, a first sensing layer and a second sensing layer is formed by applying a composition for the first sensing layer onto the first electrode layer, applying a composition for the second sensing layer onto the second electrode layer, and heating the compositions.

Each of the composition for the first sensing layer and the composition for the second sensing layer includes a conductive material having a negative temperature coefficient of resistance (NTC) respectively. The conductive material having the negative temperature coefficient of resistance is as described in the piezo-resistive pressure sensor.

Furthermore, each of the composition for the first sensing layer and the composition for the second sensing layer may further include a polymer respectively. The polymer may include a fluorine-based polymer, and a description thereof is the same as the description made in the piezo-resistive pressure sensor.

In various examples, each of the composition for the first sensing layer and the composition for the second sensing layer may include a polymer, a conductive material, and an organic solvent respectively. As the organic solvent, any general solvent that may form a sensing layer with a uniform composition due to an enhanced dispersibility of a polymer and conductive material may be used without particular limitation, and, for example, may include N-methylpyrrolidone (NMP), dimethyl sulfoxide (DMSO), dimethylformamide (DMF), acetone, and the like.

Each of the composition for the first sensing layer and the composition for the second sensing layer may include a conductive material 0.10 wt % or more, 0.15 wt % or more, 0.20 wt % or more, 0.25 wt % or more, 0.28 wt % or more, 0.30 wt % or more, 0.50 wt % or less, 0.45 wt % or less, 0.40 wt % or less, or 0.35 wt % or less based on the total composition respectively. When the content of the conductive material in the composition for the sensing layer is within the above range, the electrical responsiveness of the pressure sensor, which is the effect obtained compared to the content of the conductive material, is appropriate, the workability of the composition for the sensing layer is enhanced, and the sensitivity of the manufactured pressure sensor is enhanced.

Furthermore, each of the composition for the first sensing layer and the composition for the second sensing layer may include a polymer of 3.0 wt % or more, 4.0 wt % or more, 5.0 wt % or more, 6.0 wt % or more, 6.5 wt % or more, 10.0 wt % or less, 9.0 wt % or less, 8.0 wt % or less, or 7.5 wt % or less based on the total composition respectively. When the content of the polymer in the composition for sensing layer is within the range, the conductive material in the composition for the sensing layer is enhanced, and thus, the repeatability and reproducibility of the manufactured pressure sensor may be improved.

The application method of each of the composition for the first sensing layer and the composition for the second sensing layer may be used without particular limitation as long as it is a method that is usable when applying the composition including the conductive material, and for example, a doctor-blade may be used, but the present disclosure is not limited thereto.

Through the heat treatment, the facing surfaces of the first sensing layer and the second sensing layer are made not to be flat, e.g., to include shapes, such as a convexo-concave shape, a convex shape, and a concave shape. Because the facing surfaces of the first sensing layer and the second sensing layer are not flat, a contact area, in which they contact each other, is changed by a pressure applied to the pressure sensor, and an electrical response is changed, through the heat treatment. Thus, the pressure may be effectively sensed based on this change in the electrical response.

Furthermore, heat treatment may be performed at 50° C. or more and 70° C. or less for 5 hours or more and 20 hours or less. In various examples, the heat treatment may be performed at 55° C. or higher, 58° C. or higher, 68° C. or lower, 65° C. or lower, or 62° C. or lower for 8 hours or more, 10 hours or more, 18 hours or less, or 15 hours or less. When the temperature is at a lower limit or less during the heat treatment, it is possible to prevent a problem that the electrical characteristics of the manufactured sensor are not uniform due to an excessive agglomeration of the conductive material. Additionally, when the temperature is at an upper limit or more, it is possible to prevent a problem that the polymer material is permanently deformed to decrease the pressure sensing performance and reproducibility.

### Assembly Process

In this process, the first sensing layer and the second sensing layer are laminated to be folded or spaced apart.

Referring to FIG. 1, the piezo-resistive pressure sensor A may include a form, in which a first electrode layer 110, a first sensing layer 210, a second sensing layer 220, and a second electrode layer 120 are sequentially laminated. For example, the first sensing layer 210 and the second sensing layer 220 may contact or be spaced apart from each other. In various examples, the first sensing layer 210 and the second sensing layer 220 may be laminated to partially contact each other (see FIG. 1).

### Battery

A battery according to the present disclosure includes the above-described piezo-resistive pressure sensor. For example, the piezo-resistive pressure sensor may be installed at any position, in which a change in pressure caused due to the swelling of a battery cell in a battery may be sensed.

For example, the battery may include a stack, in which a plurality of battery cells are stacked, a pair of end plates that are disposed on an outermost side of the stack, a pair of supports that are disposed on one side of each of the end plates, and a piezo-resistive pressure sensor that is disposed between at one or more of the pair of end plates, and the support, but the battery is not limited to the shape and disposition position.

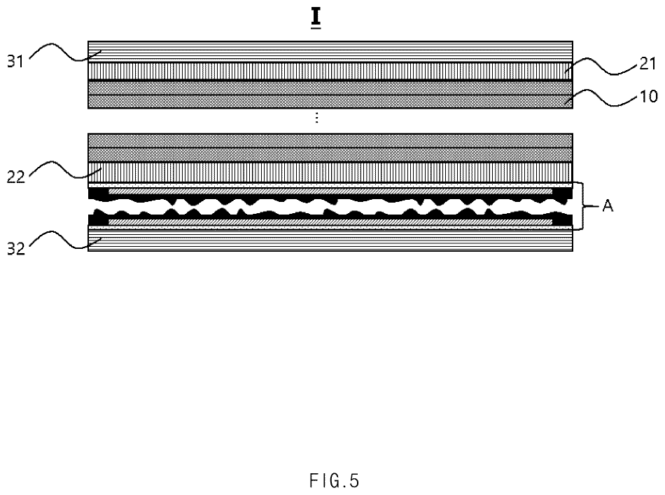

Referring to FIG. 5, a battery I may include a stack, in which a plurality of battery cells 10 are stacked, a pair of end plates 21 and 22 that are disposed on an outermost side of the stack, and a pair of supports 31 and 32 that are disposed on one surface of each of the end plates 21 and 22. The battery I may also include a piezo-resistive pressure sensor A that is disposed between at least one of the pair of end plates 21 and 22 and the supports 31 and 32.

The battery I may be applied to an environment with fluctuating temperatures. For example, an environment such as one for a mobility. For example, the mobility may include a vehicle, an aircraft, a train, a ship, or various mobile robots.

The battery I according to the present disclosure includes a piezo-resistive pressure sensor A that is less temperature dependent than the conventional piezo-resistive pressure sensor, so that the pressure sensing capability is enhanced and the abnormal signs of the battery I may be monitored in real time even in an environment with fluctuating temperatures. Thus, accidents, such as a thermal runaway, may be prevented by sensing abnormal signs, such as swelling of the battery cell early.

Furthermore, the battery I including the piezo-resistive pressure sensor A according to the present disclosure may calculate the remaining capacity and state of health of the battery I. Accordingly, it is possible to manage the state of the battery I more reliably and simply.

For example, a state of charge (SoC) may be calculated by using Equation 1 below. For example, the state of charge is a value that represents the current capacity as a percentage of the total capacity of the battery I.

$$SoC ( \% ) = \frac{V - V 0}{{V}^{′} - V 0} \qquad [ Equation 1 ]$$

In Equation 1, “V” is a voltage that is measured in real time, V₀ is a voltage that is measured when the battery is fully discharged (0% charged), and V′ is a voltage that is measured when the battery is 100% charged.

Furthermore, a state of health (SoH) may be calculated by using Equation 2 below. For example, the state of health is an index that indicates the remaining life of the battery I and the current performance state.

$$SoH ( \% ) = \frac{{V}^{″} - V 0}{{V}^{′} - V 0} \qquad [ Equation 2 ]$$

In Equation 2, V₀ is a voltage that is measured when the battery is fully discharged (0% charged), V′ is a voltage that is measured when the battery is 100% charged, and V″ is a voltage that is measured when the battery is 100% charged after long charge and discharge (degradation).

Hereinafter, the present disclosure is described in more detail through embodiments. However, the embodiments are only to help understand the present disclosure, and the scope of the present disclosure is not limited to the embodiments in any sense.

### EMBODIMENTS

### First Embodiment. Manufacturing of Piezo-resistive Pressure Sensor-1

### 1-1: Electrode Layer Forming Process

A silver nano wire (manufactured by: Doeksan Inc., having an average length: 25 micrometer (μm), and an average diameter: 50 nanometer (nm)) was added to ethanol to be 0.1 wt %, and was mixed to manufacture a first electrode layer composition.

A mask with an electrode pattern was attached to one surface of a PET substrate (manufactured by: FILMBANK, a product name: PET transparent, and has an average thickness: 188 μm) as the first base layer, and O₂ plasma treatment was performed. Thereafter, 0.3 ml of a poly-L-lysine (PLL) solution (manufactured by: Sigma-Aldrich, and a product name: Poly-L-lysine solution) was spin-coated at 1000 revolutions per minute (rpm) on the plasma-treated first base layer. Thereafter, the first electrode layer composition was injected into the mask of the electrode pattern, was applied through a doctor-blade, and was dried at 60° C. (screen printing). Thereafter, the surface was rinsed with ethanol, was blown with N₂ gas, and was thermally compressed at a pressure of 20 megapascal (MPa) and a temperature of 100° C. to remove residual ethanol and stabilize the electrode to form the first electrode layer.

### 1-2: Sensing Layer Forming Process

A carbon nano tube (CNT, manufactured by: ALADDIN, having an average length: 50 μm, and an average diameter: 8-15 nm) was added to n-methyl-2-pyrrolidone (NMP) to be 0.2 w %, and was dispersed by adding an ultrasonic wave of 100 KJ/ml. Thereafter, 6.98 wt % of polyvinylidene fluoride (PVDF, Mw: about 534,000 g/mol) with NMP content was added and was stirred at 60° C. for 12 hours to manufacture a composition for the first sensing layer.

Thereafter, a mask was put on the first electrode layer formed on the PET substrate prepared in a (1-1)-th embodiment, and the composition for the first sensing layer was applied through a doctor-blade. Thereafter, the mask was removed and was dried in a vacuum oven at 60° C. for 12 hours to form the first sensing layer (a solution casting method).

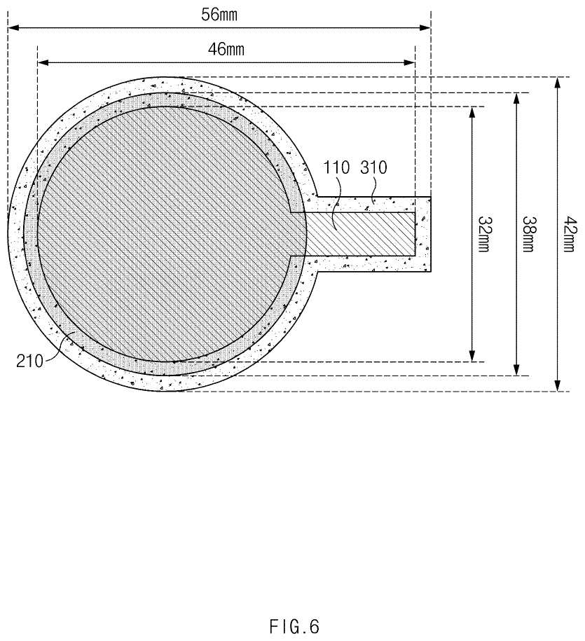

Detailed information on the first stack including the manufactured PET substrate, the first electrode layer, and the first sensing layer is as illustrated in FIG. 6.

### 1-3: Assembly Process

The first stack manufactured in a (1-2)-th embodiment and the second stack manufactured in the same manner were stacked so that the first sensing layer and the second sensing layer are laminated to face each other to manufacture a pressure sensor-1.

### Second and Third Embodiments

A pressure sensor-2 (the second embodiment) and a pressure sensor-3 (the third embodiment) were manufactured in the same manner as in the first embodiment, except that the content of silver nano wires in the first electrode layer composition was adjusted to 0.2 wt % (the second embodiment) and 0.3 wt % (the third embodiment), respectively.

### Fourth Embodiment. Forming Electrode Layer Through Deposition

As the first base layer, a PET substrate (manufactured by: FILMBANK, a product name: PET transparent, and having an average thickness: 188 μm) was inserted into the depositor, and a high vacuum environment was created. Thereafter, titanium (Ti) and silver (Ag) were used as electron beam targets to deposit first electrode layers having average thicknesses of 20 nm and 100 nm, respectively. Thereafter, a sensing layer forming process and an assembly process were performed in the same manner as in the first embodiment to manufacture a pressure sensor-4.

### Fifth Embodiment

A pressure sensor-5 was manufactured in the same manner as in the fourth embodiment, except that the content of CNT in the composition for the first sensing layer was adjusted to 0.3 wt %.

### First Reference Example

In the (1-2)-th of the first embodiment: in the sensing layer forming process, a surface untreated pressure sensor was manufactured in the same manner as in the first embodiment, except that a pre-sensing layer was used before the mask was removed and a heat treatment is performed in a vacuum oven.

### First Experimental Example. Changes in Surface Properties of Electrode Layer Based on Content of Electrode Material

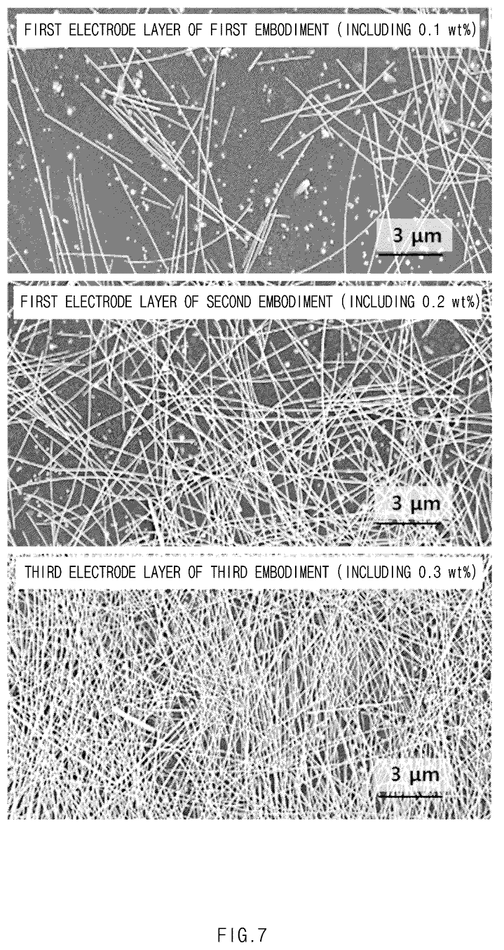

The surfaces of the first electrode layers of the first to third embodiments were observed with a scanning microscope (SEM), and the results thereof are illustrated in FIG. 7.

As illustrated in FIG. 7, it may be identified that an electrode layer having a denser conduction path was formed as the content of silver nano wires in the electrode layer composition increases.

### Second Experimental Example. Measurement of Surface Properties of Sensing Layer

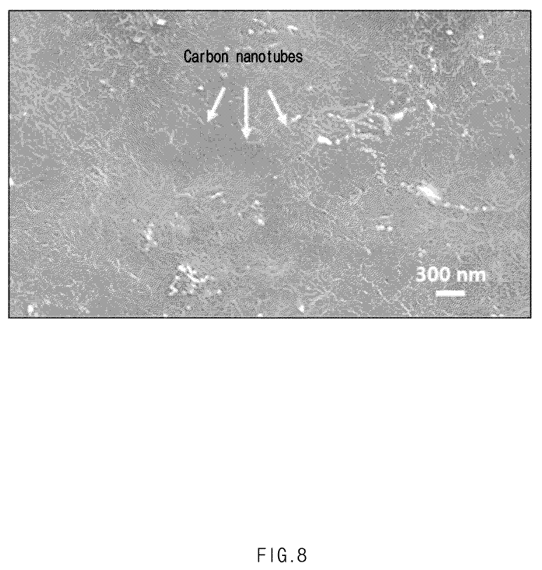

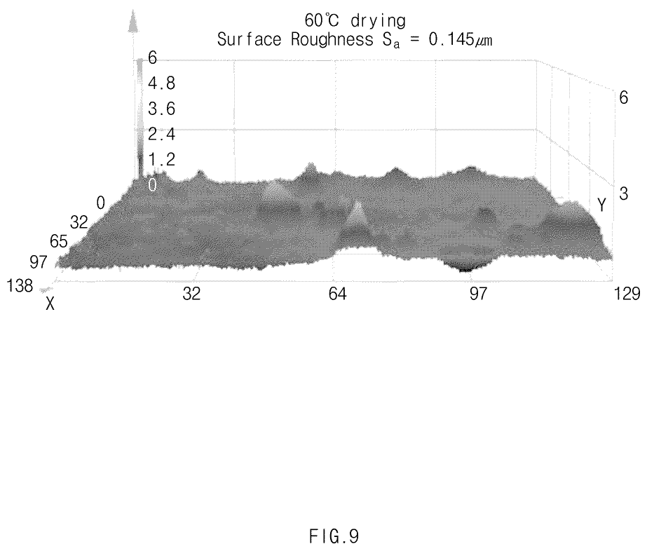

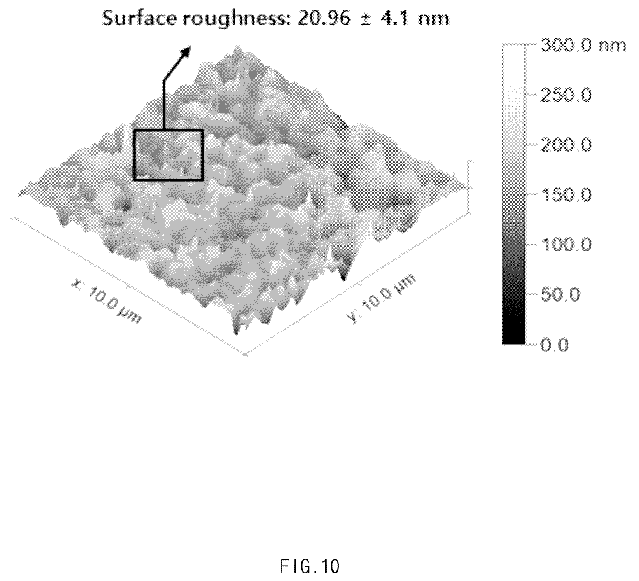

The surface of the first sensing layer manufactured in the first embodiment was observed with a scanning microscope (SEM), and the results thereof were illustrated in FIG. 8, and it was observed with a confocal microscope and the results thereof were illustrated in FIG. 9. Furthermore, the surface of the first sensing layer manufactured in the first embodiment was observed with an atomic force microscopy (AFM), and the results were illustrated in FIG. 10.

As illustrated in FIG. 8, it may be identified that carbon nano tube part (CNT) that is the conductive material formed a network in the entire sensing layer area.

Furthermore, as illustrated in FIG. 9, it may be identified that the first sensing layer analyzed by a confocal microscope had an average surface roughness (Ra) of 0.145 μm.

As illustrated in FIG. 10, the first sensing layer analyzed by an atomic force microscope had a surface roughness (Ra) of about 20.96 nm.

### Third Experimental Example. Change in Surface Properties of Sensing Layer by Heat Treatment

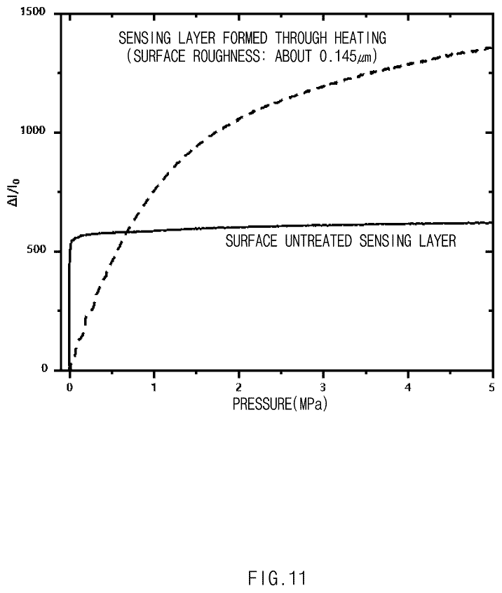

Currents were measured while applying a pressure to the pressure sensor of the first embodiment and the surface untreated pressure sensor, and the results thereof are illustrated in FIG. 11.

As illustrated in FIG. 11, it may be identified that the sensing layer (heating treatment) of the first embodiment had an enhanced sensitivity of up to 926.3 MPa-1 and a wide sensing range of less than 5 MPa. The pre-sensing layer with a flat surface due to the surface untreated manufactured in the first reference example showed little change after a signal appeared instantaneously when two contacted each other. Through this, it may be identified that the difference in surface roughness (Ra) greatly affects the pressure sensing performance.

### Fourth Test Example Evaluation of Characteristics of Pressure Sensor

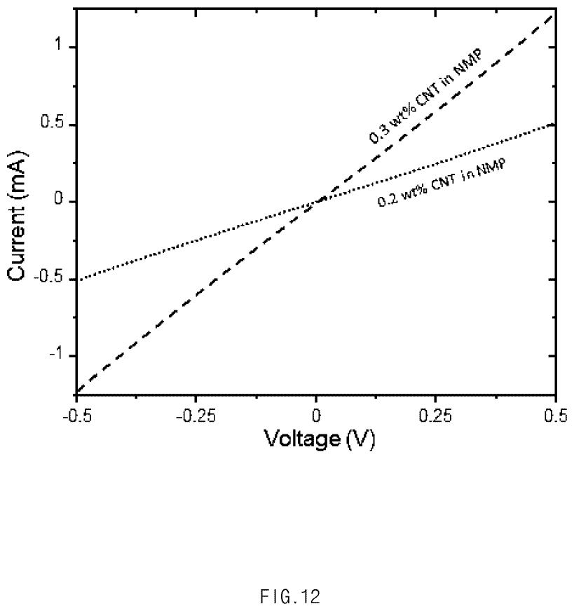

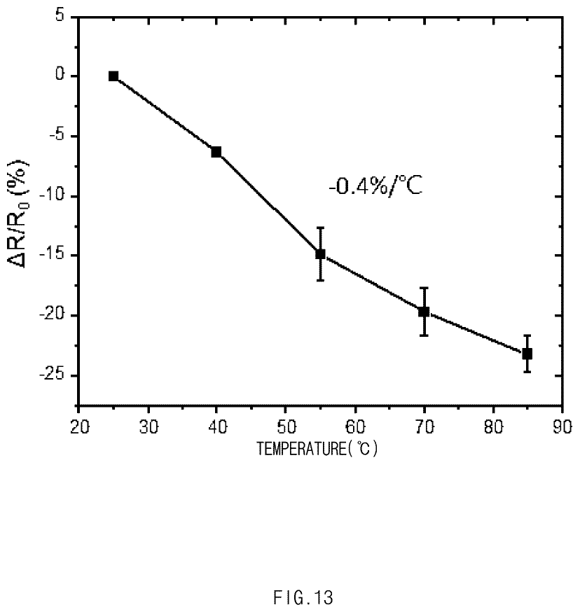

The current “I” based on voltage “V” was measured for the pressure sensor of the fourth embodiment (including a Ti—Ag deposited electrode layer and a sensing layer containing 0.2 wt % of CNT) and the pressure sensor of the fifth embodiment (including a Ti—Ag deposited electrode layer and a sensing layer containing 0.3 wt % of CNT), and the temperature coefficient of resistance (TCR) was measured for the pressure sensor of the fourth embodiment. A measured current-voltage curve is illustrated in FIG. 12, and a TCR result is illustrated in FIG. 13.

As illustrated in FIGS. 12 and 13, it may be identified that the pressure sensor of the embodiment had a resistance value of 0.4 kΩ to 1Ω (see FIG. 12), and had a negative temperature coefficient of resistance (negative TCR) of about-0.4%/° C.

### Sixth to Eleventh Embodiments

An electrode layer was formed in the same manner as in the (1-1)-th embodiment, except that the content of silver nano wires (AgNW), which are electrode materials in the electrode layer composition, was adjusted to 0.1 wt %, 0.2 wt %, or 0.3 wt % based on the weight of ethanol.

Furthermore, a sensing layer was formed in the same manner as the (1-2)-th embodiment, except that the content of the carbon nano tubes (CNT), which are the conductive material in the composition for sensing layers, was adjusted to 0.20%, 0.25%, or 0.30 wt % based on the weight of n-methyl-2-pyrrolidone (NMP).

Furthermore, the weight ratio of the components based on the total amount of the electrode material (AgNW), the conductive material (CNT), and the polymer (PVDF) for the entire manufactured pressure sensor is illustrated in Table 1 below, and the ratio in parentheses is the weight ratio between the components above.

TABLE 1

| | Electrode of AgNW of | Electrode of AgNW of | Electrode of AgNW of |
|---|---|---|---|
| | 0.1 wt % | 0.2 wt % | 0.3 wt % |
| Sensing layer | Sixth embodiment | Eighth embodiment | — |
| containing CNT of | (1:2.57:88.86) | (1:1.33:46.07) | |
| 0.2 wt % | | | |
| Sensing layer | Seventh embodiment | Ninth embodiment | — |
| containing CNT of | (1:3.21:88.86) | (1:1.67:46.07) | |
| 0.25 wt % | | | |
| Sensing layer | — | Tenth embodiment | Eleventh embodiment |
| containing CNT of | | (1:1.96:46.07) | (1:1.29:30.34) |
| 0.3 wt % | | | |

### Fifth Experimental Example. Measurement of Change in Temperature Sensitivity of Pressure Sensor Based on Change in Content of Electrode Material of Electrode Layer and Content of Conductive Material of Sensing Layer

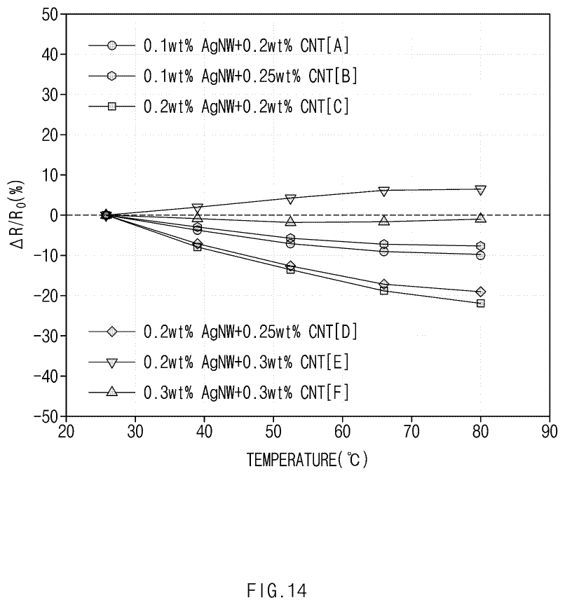

An amount of a change in resistance based on temperature was measured for the pressure sensors of the sixth to eleventh embodiments, and the results thereof are illustrated in FIG. 14. Furthermore, Table 2 illustrates the measurement results of the temperature coefficient of resistance of the pressure sensor manufactured by adjusting the content of AgNW in the electrode layer and the content of CNT in the sensing layer.

TABLE 2

| | Temperature coefficient of resistance |
|---|---|
| Sixth embodiment | −0.15%/K [A] |
| Seventh embodiment | −0.13%/K [B] |
| Eighth embodiment | −0.4%/K [C] |
| Ninth embodiment | −0.35%/K [D] |
| Tenth embodiment | +0.1%/K [E] |
| Eleventh embodiment | +0.015%/K [F] |

As illustrated in FIG. 14 and Table 2, the temperature coefficient of resistance was changed as the sensitivity based on the temperature of the pressure sensor manufactured based on the content of AgNW of the electrode layer and the content of CNT of the sensing layer was changed. For example, it is expected that the pressure sensor of the eleventh embodiment including an electrode layer containing AgNW of 0.3 wt % and a sensing layer containing CNT of 0.3 wt % has a low temperature sensitivity due to a low resistance change based on temperature, and has an enhanced pressure sensing capability even in a temperature-changing environment, such as a vehicle.

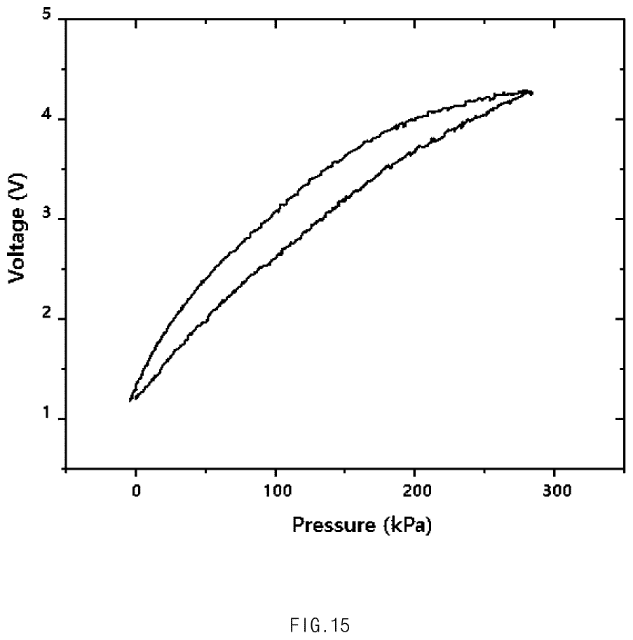

Furthermore, a change in a voltage based on the applied pressure was measured for the pressure sensor of the eleventh embodiment including an electrode layer containing AgNW of 0.3 wt % and a sensing layer including CNT of 0.3 wt %, and the results thereof are illustrated in FIG. 15.

As illustrated in FIG. 15, it may be seen that a voltage change is appropriate based on a pressure applied to the pressure sensor, and thus is appropriate as a pressure sensor.

### Sixth Experimental Example

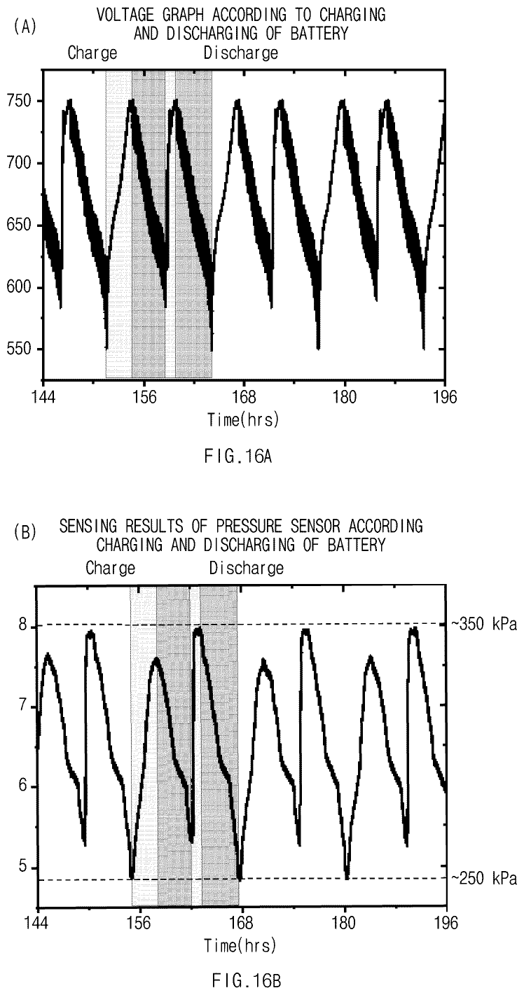

The pressure sensor of the eleventh embodiment was inserted between the cells of the battery module, and a change in a voltage e based on charging and discharging of the battery and a change in a voltage sensed by the pressure sensor were measured, and the results thereof are illustrated in FIGS. 16A and 16B.

As illustrated in FIGS. 16A and 16B, a signal of a pressure sensor may be identified similar to a voltage signal behavior of a battery pack when a battery is charged and discharged. Furthermore, it may be seen that based on the calibration value analyzed by using the universal material tester, the initial pressure was about 250 kPa, and the pressure during charging was about 350 kPa, and the results were used to illustrate that real-time monitoring of the battery condition and pre-sensing of abnormalities were possible. Furthermore, it may be seen that because the pressure sensor according to the present disclosure has very low temperature sensitivity and thus has little effect on the temperature change of the battery due to charging and discharging, it is possible to more accurately sense the change in the pressure in the battery.

Because the piezo-resistive pressure sensor according to the present disclosure has a lower temperature dependence compared to the conventional piezo-resistive pressure sensor, it has an enhanced pressure sensing capability even in a temperature-changing environment, such as a vehicle. Thus, the piezo-resistive pressure sensor is very suitable for monitoring an abnormality of the battery in real time. Furthermore, the remaining capacity and deterioration degree of the battery may be calculated from the results measured by the pressure sensor, and thus, it is very suitable for monitoring the current state of the battery.

What is claimed is:

1. A piezo-resistive pressure sensor comprising:
a first electrode layer including an electrode material having a positive temperature coefficient of resistance (PTC);
a first sensing layer laminated on the first electrode layer, and including a conductive material having a negative temperature of coefficient of resistance (NTC);
a second sensing layer laminated to contact or be spaced apart from the first sensing layer, and including a conductive material having a negative temperature coefficient of resistance (NTC); and
a second electrode layer laminated on the second sensing layer, and including an electrode material having a positive temperature coefficient of resistance (PTC).

2. The piezo-resistive pressure sensor of claim 1, wherein the electrode material comprises one or more selected from the group consisting of silver (Ag), gold, copper, platinum, palladium, nickel, aluminum, cobalt, molybdenum, tungsten, titanium, and chromium.

3. The piezo-resistive pressure sensor of claim 1, wherein surface roughnesses of the first sensing layer and the second sensing layer are 0.001 μm or more and 1000 μm or less, respectively.

4. The piezo-resistive pressure sensor of claim 1, wherein the first sensing layer and the second sensing layer include a polymer respectively.

5. The piezo-resistive pressure sensor of claim 4, wherein the polymer comprises a fluorine-based polymer.

6. The piezo-resistive pressure sensor of claim 1, wherein the conductive material comprises one or more selected from the group consisting of a carbon nano material and a semiconductor.

7. The piezo-resistive pressure sensor of claim 6, wherein the carbon nano material comprises one or more selected from the group consisting of a carbon nanotube (CNT), graphene, carbon black, and graphite.

8. The piezo-resistive pressure sensor of claim 6, wherein the semiconductor comprises one or more selected from the group consisting of ZnO, TiO₂, WO₃, SnO₂, NiO, CuO, Cr₂O₃, CrO₃, CrO, CoO, Co₂O₃, and Co₃O₄.

9. The piezo-resistive pressure sensor of claim 4, wherein the electrode material, the conductive material, and the polymer are included in a weight ratio of 1:0.90 or more and 3.5 or less: 25 or more and 90 or less.

10. The piezo-resistive pressure sensor of claim 1, wherein with respect to a cross section of the piezo-resistive pressure sensor,
the first sensing layer covers a surface and a side surface of the first electrode layer, and
the second sensing layer covers a surface and a side surface of the second electrode layer.

11. A method for manufacturing a piezo-resistive pressure sensor, the method comprising:
an electrode layer forming process of forming a first electrode layer and a second electrode layer;
a sensing layer forming process of forming a first sensing layer and a second sensing layer, by applying a composition for the first sensing layer onto the first electrode layer, applying a composition for the second sensing layer onto the second electrode layer, and heating the compositions; and
an assembly process of laminating the first sensing layer and the second sensing layer such that the first sensing layer and the second sensing layer contact or are spaced apart from each other,
wherein the first electrode layer and the second electrode layer include an electrode material having a positive temperature coefficient of resistance (PTC) respectively, and
wherein the composition for the first sensing layer and the composition for the second sensing layer include a conductive material having a negative temperature coefficient of resistance (NTC) respectively.

12. The method of claim 11, wherein the composition for the first sensing layer and the composition for the second sensing layer comprise a polymer, a conductive material and an organic solvent respectively.

13. The method of claim 11, wherein in the sensing layer forming process, the heating is performed for 5 hours to 20 hours at 50° C. or more 70° C. or less.

14. A battery comprising:
a piezo-resistive pressure sensor including:
a first electrode layer including an electrode material having a positive temperature coefficient of resistance (PTC);
a first sensing layer laminated on the first electrode layer, and including a conductive material having a negative temperature of coefficient of resistance (NTC);
a second sensing layer laminated to contact or be spaced apart from the first sensing layer, and including a conductive material having a negative temperature coefficient of resistance (NTC); and
a second electrode layer laminated on the second sensing layer, and including an electrode material having a positive temperature coefficient of resistance (PTC).

15. The battery of claim 14, wherein the electrode material comprises one or more selected from the group consisting of silver (Ag), gold, copper, platinum, palladium, nickel, aluminum, cobalt, molybdenum, tungsten, titanium, and chromium.

16. The battery of claim 14, wherein surface roughnesses of the first sensing layer and the second sensing layer are 0.001 μm or more and 1000 μm or less respectively.

17. The battery of claim 14, wherein the first sensing layer and the second sensing layer include a polymer respectively.

18. The battery of claim 17, wherein the polymer comprises a fluorine-based polymer.

19. The battery of claim 14, wherein the conductive material comprises one or more selected from the group consisting of a carbon nano material and a semiconductor.

20. The battery of claim 19, wherein the carbon nano material comprises one or more selected from the group consisting of a carbon nanotube (CNT), graphene, carbon black, and graphite.
